(19) United States
(12) Patent Application Publication
(10) Pub. No.: US 2008/0320320 A1
(43) Pub. Date: Dec. 25, 2008

(54) MOBILE POWER CONTROL APPARATUS AND METHOD

(76) Inventors: Peter T. Li, Portland, OR (US); Don J. Nguyen, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/765,870

(22) Filed: Jun. 20, 2007

(51) Int. Cl. G06F 1/26

(52) U.S. Cl. 713/300

(57) ABSTRACT

Disclosed herein are approaches for reducing the difference in voltage between a DC power source and a system supply voltage for a mobile system, for example, to reduce over-voltages, inrush currents, and power conversion inefficiencies when a DC source such as an adapter is connected to the mobile system.

### BACKGROUND

A mobile computing system such as a so-called laptop or notebook computer has one or more battery packs, each typically comprising two or more cells, to provide the system with power when an external power source (e.g., an AC/DC adaptor) is not available. Cells today typically generate 3 to 4.2 volts (V), so battery packs, which commonly have two to four cells connected together in series, can provide, e.g., anywhere from 6 to 16.8 V.

In order to charge a battery, an adaptor needs to have a higher voltage than the battery pack(s) to be charged. In addition, they typically need to be able to provide more power than is required by the mobile system so that they can supply power to charge the battery, as well as to power the system. Conventional adaptors commonly provide a fixed output voltage, and so to be able to provide a sufficient voltage for different systems, they typically provide relatively high voltages, e.g., up to 20 V.

Thus, in some cases where an adaptor with a high voltage is paired with a mobile system with a relatively low battery pack voltage, there can be large voltage differences, resulting in high inrush currents. To solve this problem, some conventional systems employ components with high current ratings to tolerate the high currents, while other solutions may use so-called “soft start” circuitry to limit the inrush current. Unfortunately, these approaches can be costly and/or can lead to reliability issues. Accordingly, new solutions are desired.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a schematic diagram of a circuit to couple a power source to a mobile system in accordance with some embodiments.

FIG. 2 is a graph showing the relationship between supplied output voltage and applied control current for a power source suitable for use with the circuit of FIG. 1 in accordance with some embodiments.

FIG. 3 is a flow diagram showing a routine to couple a power source to a mobile system in accordance with some embodiments.

### DETAILED DESCRIPTION

Disclosed herein are approaches for reducing the difference in voltage between a DC power source and a system supply voltage for a mobile system, for example, to reduce over-voltages, inrush currents, and power conversion inefficiencies when a DC source such as an adapter is connected to the mobile system.

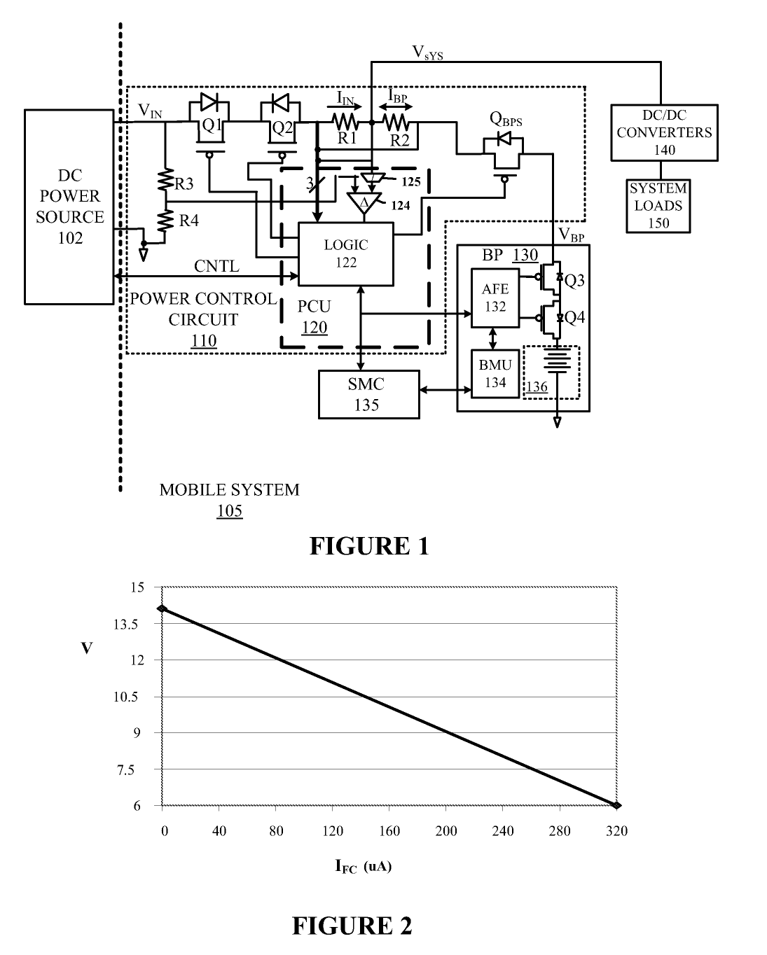

FIG. 1 shows a power control circuit 110 for controlling a battery pack 130 and DC power source 102 to provide power to a mobile system 105. The mobile system 105 may be any type of portable computing system such as a portable computer, personal digital assistant, cellular phone, or the like. For illustrative purposes, however, it may be treated as a portable computer such as a so-called notebook or laptop computer.

The DC power source 102 may be implemented with any suitable DC power source (e.g., AC/DC adapter, fuel cell module, alternative electricity source, etc.) whose output voltage can be controlled by the power control circuit 110 with one or more control signals. For example, it could be implemented with an AC/DC adaptor such as is described in the concurrently filed U.S. patent application to the same inventors entitled: “AC-TO-DC ADAPTER FOR MOBILE SYSTEM”, incorporated by reference herein. For example, the output voltage for this adaptor could be controlled by a current signal whose magnitude is inversely proportional to the voltage generated by the adaptor. A curve showing the voltage vs. current relationship for such an exemplary adaptor is shown in FIG. 2.

In the depicted embodiment, the mobile system 105 comprises the power control circuit 110, battery pack 130, system management controller (SMC) 135, one or more DC/DC converters 140, and loads 150 such as one or more processors, I/O components, network interface components, and the like. In some embodiments, for example, the power control circuit may constitute an integrated circuit and/or discrete components housed on a motherboard of the mobile system 105. (It may be desirable to implement as many of the power control circuit functions, as is reasonably possible, on one or more chips so as to minimize discrete component count and cost.) It should be appreciated, however, that the power control circuit could alternatively be implemented, wholly or partially, in the DC power source 102, battery pack 130, and/or in other parts of the mobile system 105 or in some other module.

The battery pack 130 may be implemented with any suitable battery pack(s) configuration that can source an appropriate voltage (V_{BP}) with sufficient power for the mobile system 105. It could comprise one or more packs (e.g., selectably coupled together in parallel). Likewise, it may be conventional, as shown in the depicted embodiment, or alternatively, as with other components discussed herein, it could comprise future battery cell innovations. For example, it is believed that future cells will use different materials and/or configurations enabling them to provide lower or higher voltages with improved power and storage characteristics.

The depicted battery pack 130 comprises a plurality of series-coupled cells 136 (three in the depicted embodiment); transistor switches Q3, Q4; an analog front-end (AFE) circuit 132; and a battery management unit (BMU) circuit 134. The transistor switches Q3, Q4 are implemented with PMOS transistors, configured so that they have an associated rectification component in the illustrated directions. They are coupled between the cells 136 and BP output terminal (V_{BP}) to control whether or not the collective voltage generated by cells 136 is provided to the BP output terminal. Each of the three cells, for example, could generate a voltage (when fully charged) of 4.2V, for example, so that V_{BP} would be 12.6 V when the cells are fully charged.

The AFE controls transistor switches Q3 and Q4 for charging, discharging, or isolating cells 136 in response to commands from either the power control circuit 110 (via the PCU 120, discussed below), the SMC 135, or the BMU 134. The BMU monitors environmental conditions such as temperature in the battery pack 130 and provides them to the mobile system 105 through the SMC 135 and can directly control switches Q3, Q4 through the AFE 132, for example, to shut down the battery pack when an over-temperature condition occurs. It also may provide information about the battery pack (e.g., charging and power limits) to either or both the PCU 120 and system via the SMC 135. Likewise, the PCU 120 and SMC 135 can also control switches Q3, Q4 through the AFE 132 for engaging and disengaging the battery pack in order to charge it, isolate it, or couple it to the system to provide it with power.

The power control circuit 110 generally comprises a power control unit (PCU) circuit 120, resistors: R1-R4, and transistor switches Q1, Q2, and Q_{BPS}, all coupled together as shown. As with the battery pack switches Q3, Q4, the transistor switches (Q1, Q2, and Q_{BPS}) are implemented with P MOS transistors, configured so that rectification across either P-N or N-P junctions is attained as indicated. It should be appreciated, however, that any suitable component or combination of components could be used to implement these switches. For example, pass gates, NMOS transistors, or other transistor types, with or without separate diodes, could be used).

Transistors Q1 and Q2 serve to couple/decouple the system voltage node (V_{SYS}) to/from the DC power source voltage node (V_{IN}). Q1 is used to prevent the system supply (V_{SYS}) from being exposed when the power source 102 is removed, and Q2 is used to reject non-compliant power sources and/or for over voltage protection. Transistor switch Q_{BPS} is used to controllably couple the battery pack voltage (V_{BP}) to, or decouple it from, the system voltage (V_{SYS}). (It should be appreciated that not all of these switches may be needed or even desired in all embodiments. In other embodiments, additional switches may be used or equivalent switches may be located in different places. For example, Q2 may not be used in some embodiments and additional switches may be employed in embodiments such as when additional isolation is desired or when additional battery packs are employed.)

R1 and R2 serve as current sense resistors and are used by the PCU 120 to measure DC power source current (I_{IN}) and battery pack current (I_{BP}). In this way, the PCU 120 can monitor the power being sourced by the power source 102, as well as the power being charged into or sourced from the battery pack 130. Since the sense resistors R1, R2 are in power delivery paths, it may be desirable to make their resistances as small and accurate as is reasonably possible depending on design concerns and the like. Along these lines, it should be appreciated that other techniques for measuring power or current could be used. For example, a current loop or current mirror circuit (e.g., with a relatively large transistor in the power delivery path) could be used. In fact, current mirror circuits could be configured out of the switch transistors (e.g., Q1, Q_{BPS}), which are in the power delivery paths anyway. (Note that current or power sensing is not necessarily critical to implementation of embodiments of the present invention and thus could be omitted.)

Resistors R3 and R4 serve as voltage division resistors to reduce the sensed input voltage (V_{IN}) to a level that can efficiently be handled by PCU 120, which may be implemented in an integrated circuit.

The PCU 120, among other things, functions to control the switches (Q1, Q2, and Q_{BPS}) based on the magnitudes of the DC source voltage (V_{IN}) and the system voltage (V_{SYS}) to couple the DC source 102 to the battery pack 130 when V_{IN} is sufficiently close to V_{SYS} and to control the DC source 102 to change (e.g., reduce) V_{IN} through a control signal (CNTL) to make them sufficiently close to one another. (Note that in some embodiments, it may also control other parameters such as charge rates, e.g., based on the afore discussed sensed currents, power source power ratings, and battery pack power ratings. See, for example, concurrently filed applications to the same inventors entitled: “AC-TO-DC ADAPTER FOR MOBILE SYSTEM,” and “BATTERY PULSE CHARGING METHOD AND APPARATUS,” incorporated by reference herein.

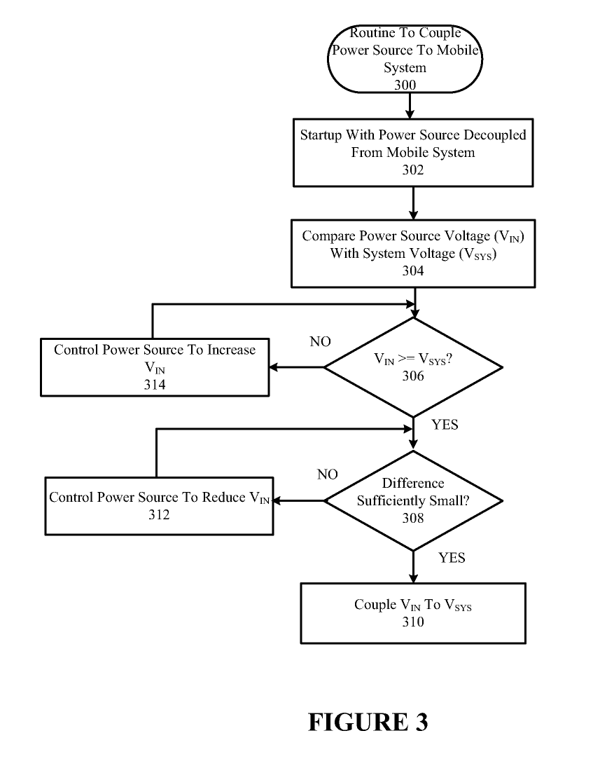

In the depicted embodiment, the PCU 120 comprises logic 122, difference circuit 124, and divider circuit 125, coupled together as shown. The divider circuit 125 reduces V_{SYS} by an amount corresponding to the voltage reduction of V_{IN} by R3, R4 so that difference circuit 124 can generate a meaningful difference between them. This difference, which corresponds to V_{IN}−V_{SYS}, is provided to the logic 122. As set forth in more detail below with regard to FIG. 3, the logic 122 controls the DC power source 102, if necessary, to force the difference to be sufficiently small. It controls the power source 102 through control signal CNTL, which in some embodiments, may be a current signal inversely controlling V_{IN} as illustrated in FIG. 2. Once V_{IN} and V_{SYS} are reasonably close to one another, the logic 122 controls switches Q1, Q2 so that the power source 102 can provide power to the system. (Q_{BPS} will typically already be closed, with V_{BP} serving as the source for V_{SYS}. Note, however, that this is not necessary. For example, in an alternative embodiment, a signal from the battery pack could be provided to the difference circuit 124 so that the voltage difference between the power source voltage (V_{IN})) and battery pack voltage (V_{BP}) are directly determined. From here, Q_{BPS}, which could have been closed or opened, could be closed, e.g., if desirable to charge the battery pack or even controlled to be open, e.g., if all Power source 102 power is desired for the mobile system 105.)

The PCU 120, including logic 122, difference circuit 124, and divider 125, may be implemented with any suitable combination of analog and/or digital circuits to perform various operations including those set forth herein. For example, whether or not wholly or partially integrated, it could be implemented and with combinations of particular analog and/or digital circuits, or alternatively, it could partially or wholly incorporate more generalized circuitry such as a microcontroller with available microcode. Accordingly, different operations could be performed digitally (e.g., with the use of A/D converters to digitize the incoming analog signals, which could then be processed using digital logic), they could be performed in an analog manner, or they could be performed using both digital and analog techniques.

FIG. 3 shows a routine 300 for coupling a power source such as power source 102 to a mobile system such as system 105, in accordance with some embodiments. This routine may be executed by the PCU 120 from the power control circuit 110 of FIG. 1. Initially, at 302, the system starts up with the power source 102 being electrically decoupled from the system supply node (V_{SYS}) Accordingly, it starts up with Q1, Q2, or both Q1 and Q2 turned off (opened).

Next, at 304, the power source voltage (V_{IN}) is compared, e.g., a difference is determined, with the system voltage (V_{SYS}). This difference may be obtained directly, or alternatively, as with the circuit of FIG. 1, it may be determined indirectly by comparing (or measuring a difference between) modified (e.g., reduced through equivalent voltage division) versions of the voltages. Thus, even though the actual voltage difference may not be measured, the difference can effectively be determined by comparing equivalently reduced or otherwise derived versions of the voltages.

At 306, if V_{IN} is greater or equal to V_{SYS}, then the routine proceeds to 308. Otherwise, it goes to 314, and the power source is controlled to increase V_{IN}. (It is possible that the power source voltage could be less than the system/battery voltage, so the routine accounts for this condition.)

If it was determined that V_{IN} is greater than V_{SYS}, than at 308, it is determined if the difference between V_{IN} and V_{SYS} is sufficiently small, e.g., if they are within 5% of one another. This tolerance will generally depend on the voltage and current ratings of the relevant components in the power control circuit, battery pack, and system. If they are sufficiently close to one another, then at 310, the routine couples the power source to the system. With the configuration of FIG. 1, this would correspond to the PCU 120 turning on (closing) both Q1 and Q2.

On the other hand, if V_{IN} is not sufficiently close to V_{SYS}, then it instead proceeds to 312 where the power source is controlled to reduce its output voltage (V_{IN}). For example, with a power source having a voltage/control current response as shown in FIG. 2, this corresponds to the PCU increasing the CNTL current to reduce V_{IN}. From here, it returns to 308 and repeats the steps as discussed until the voltages are sufficiently close, with the power source then being coupled to the system.

In the preceding description, numerous specific details have been set forth. However, it is understood that embodiments of the invention may be practiced without these specific details. In other instances, well-known circuits, structures and techniques may have not been shown in detail in order not to obscure an understanding of the description. With this in mind, references to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the preceding description and following claims, the following terms should be construed as follows: The terms “coupled” and “connected,” along with their derivatives, may be used. It should be understood that these terms are not intended as synonyms for each other. Rather, in particular embodiments, “connected” is used to indicate that two or more elements are in direct physical or electrical contact with each other. “Coupled” is used to indicate that two or more elements co-operate or interact with each other, but they may or may not be in direct physical or electrical contact.

The term “PMOS transistor” refers to a P-type metal oxide semiconductor field effect transistor. Likewise, “NMOS transistor” refers to an N-type metal oxide semiconductor field effect transistor. It should be appreciated that whenever the terms: “MOS transistor”, “NMOS transistor”, or “PMOS transistor” are used, unless otherwise expressly indicated or dictated by the nature of their use, they are being used in an exemplary manner. They encompass the different varieties of MOS devices including devices with different VTs, material types, insulator thicknesses, gate(s) configurations, to mention just a few. Moreover, unless specifically referred to as MOS or the like, the term transistor can include other suitable transistor types, e.g., junction-field-effect transistors, bipolar-junction transistors, metal semiconductor FETs, and various types of three dimensional transistors, MOS or otherwise, known today or not yet developed.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like.

It should also be appreciated that in some of the drawings, signal conductor lines are represented with lines. Some may be thicker, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

It should be appreciated that example sizes/models/values/ranges may have been given, although the present invention is not limited to the same. As manufacturing techniques (e.g., photolithography) mature over time, it is expected that devices of smaller size could be manufactured. In addition, well known power/ground connections to IC chips and other components may or may not be shown within the FIGS, for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. An apparatus, comprising:
a circuit to determine a voltage difference between a voltage at a DC power source node and a voltage at a mobile system supply node, to control the DC power source to adjust the voltage at its node until the voltage difference is sufficiently small, and to electrically couple the DC power source node to the mobile system supply node to supply it with power once the voltage difference is sufficiently small.

2. The apparatus of claim 1, in which the circuit indirectly determines the voltage difference by determining a difference between modified versions of the power source node voltage and mobile system supply node voltage.

3. The apparatus of claim 1, in which the mobile system comprises a battery pack, and the voltage at the mobile system supply node corresponds to a voltage generated by the battery pack.

4. The apparatus of claim 1, in which the DC power source is an AC/DC adapter.

5. The apparatus of claim 1, in which the circuit comprises a first transistor switch coupled between the DC power source node and the mobile system supply node, the transistor switch having a rectifier forward biased in a direction from the DC power source node to the mobile system supply node.

6. The apparatus of claim 5, comprising a second transistor switch coupled between the first transistor switch and the mobile system supply node, said second transistor switch having a rectifier forward biased in a direction from the mobile system supply node to the first transistor switch.

7. The apparatus of claim 1, in which the mobile system is a portable computer.

8. The apparatus of claim 1, in which the circuit comprises a power control unit with an analog difference amplifier to determine the voltage difference between the voltage at the DC power source node and the voltage at the mobile system supply node.

9. The apparatus of claim 8, in which the circuit is part of a module apart from the mobile system and battery pack.

10. The apparatus of claim 1, in which the circuit decouples the DC power source node from the mobile system node when it powers up.

11. A method, comprising:
determining a difference between a power source voltage and a battery pack voltage, said battery pack used to supply power to a mobile system;
adjusting the power source voltage to reduce the difference to be within an acceptable level; and
coupling the power source voltage to the mobile system to provide it with power once the difference is within the acceptable level.

12. The method of claim 11, in which the difference is determined indirectly by determining a difference between modified versions of the power source and battery pack voltages.

13. The method of claim 11, wherein coupling the power source voltage to the mobile system comprises coupling the power source voltage to the battery pack.

14. The method of claim 11, comprising ensuring that the power source voltage is decoupled from the mobile system and battery pack when it is connected to the mobile system.

15. The method of claim 14, in which the power source is an AC/DC adapter, and the mobile system is a portable computer.

16. The method of claim 11, in which the power source voltage is coupled to the mobile system when the power source voltage is within 5% of the battery pack voltage.

17. The method of claim 11, in which the power source voltage is adjusted by changing a control current provided to the power source.
